(19) United States
(12) Patent Application Publication
(10) Pub. No.: US 2024/0312694 A1
(43) Pub. Date: Sep. 19, 2024

(54) COIL COMPONENT

(71) Applicant: SAMSUNG ELECTRO-MECHANICS CO., LTD., Suwon-si, Gyeonggi-do (KR)

(72) Inventors: Han LEE, Suwon-si, Gyeonggi-do (KR); Boum Seock KIM, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/516,102

(22) Filed: Nov. 21, 2023

(30) Foreign Application Priority Data
Mar. 14, 2023 (KR) 10-2023-0033349

(51) Int. Cl. H01F 27/29; H01F 27/24

(52) U.S. Cl. CPC H01F 27/29; H01F 27/24

(57) ABSTRACT

A coil component includes a body; a support substrate disposed in the body and having one surface and the other surface; a first coil disposed on the one surface of the support substrate and having a first core; a second coil disposed on the other surface of the support substrate and having a second core; a first lead-out portion disposed on the other surface of the support substrate and connected to the first coil; and a second lead-out portion disposed on the one surface of the support substrate and connected to the second coil, wherein the first core includes a first shared core overlapping the second core and a first nonshared core not overlapping the second core, and wherein the second core includes a second shared core overlapping the first core and a second nonshared core not overlapping the first core.

### CROSS-REFERENCE TO RELATED APPLICATION (S)

This application claims benefit of priority to Korean Patent Application No. 10-2023-0033349 filed on Mar. 14, 2023 in the Korean Intellectual Properties Office, the disclosure of which is incorporated herein by reference in its entirety.

### BACKGROUND

### 1. Technical Field

The present disclosure relates to a coil component.

### 2. Description of Related Art

With reductions in sizes and thicknesses of electronic devices such as a digital TV, a mobile phone, and a laptop, a coil component applied to an electronic device may be necessary to be miniaturized and thinned, and to meet demand, research and development of various types of coil component such as a winding-type coil component or a thin-film type coil component have been actively conducted.

A major issue in reduction of a size and a thickness of a coil component may be to implement the same properties despite the reduction of a size and a thickness. To satisfy these requirements, a ratio of a magnetic material in a core filled with a magnetic material may need to be increased, but there may be a limitation in increasing the ratio due to strength of an inductor body and changes in frequency properties according to insulation.

There has been an increasing demand for a component in an array form having the advantage of reducing a mounting area of a coil component. The coil electronic component in an array form may have a noncoupled or coupled inductor form or a mixture form thereof according to a coupling coefficient of mutual inductance between a plurality of coil portions.

In a coupled inductor, leakage inductance may be related to output current ripple, and mutual inductance may be related to inductor current ripple. In order for the coupled inductor to have the same output current ripple as a general noncoupled inductor, leakage inductance of the coupled inductor may need to be the same as that of a general noncoupled inductor. Also, when mutual inductance increases, a coupling coefficient k may increase, and accordingly, inductor current ripple may be reduced.

Accordingly, as the coupled inductor has the same output current ripple as that of a general noncoupled inductor in the same size as that of a general noncoupled inductor and inductor current ripple is reduced, efficiency may be increased without increasing the mounting area. To increase the efficiency of the inductor array chip while maintaining a chip size, a coupled inductor having a high coupling coefficient by increasing mutual inductance may be required. Alternatively, a coupled inductor having a low coupling coefficient may be required according to the needs of an application, and in this case, a coupling coefficient between coil portions may need to be lowered to an appropriate level.

### SUMMARY

An example embodiment of the present disclosure is to effectively adjust coupling inductance between coil portions in a coil component having a coupled inductor structure.

According to an example embodiment of the present disclosure, a coil component includes a body having a first surface and a second surface opposing each other in a first direction, a third surface and a fourth surface opposing each other in a second direction, a fifth surface and a sixth surface opposing each other in a third direction; a support substrate disposed in the body and having one surface and the other surface; a first coil disposed on the one surface of the support substrate and having a first core; a second coil disposed on the other surface of the support substrate and having a second core; a first lead-out portion disposed on the other surface of the support substrate and connected to the first coil; and a second lead-out portion disposed on the one surface of the support substrate and connected to the second coil, wherein the first core includes a first shared core overlapping the second core and a first nonshared core not overlapping the second core, and wherein the second core includes a second shared core overlapping the first core and a second nonshared core not overlapping the first core.

According to an example embodiment of the present disclosure, a coil component includes a body; a support substrate disposed in the body and having one surface and the other surface; a first coil disposed on the one surface of the support substrate and having a first core; a second coil disposed on the other surface of the support substrate and having a second core; a first lead-out portion disposed on the other surface of the support substrate and connected to the first coil; and a second lead-out portion disposed on the one surface of the support substrate and connected to the second coil, wherein the first core includes a first shared core overlapping the second core and a first nonshared core not overlapping the second core, wherein the second core includes a second shared core overlapping the first core and a second nonshared core not overlapping the first core, and wherein, in a plan view of the coil component, the first and second nonshared cores are disposed on a same side of the first and second shared cores.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a coil component according to an embodiment of the present disclosure;

FIG. 2 is a diagram illustrating a coil component viewed from above;

FIG. 3 is a diagram illustrating coil and a lead-out portion included in the coil component illustrated in FIG. 1;

FIGS. 4 to 6 are diagrams illustrating various arrangements of vias according to an embodiment of the present disclosure;

FIG. 7 is a diagram illustrating a first core of a first coil and a second core of a second coil;

FIG. 8 is a diagram illustrating a core included in the coil component illustrated in FIG. 1, illustrating the coil component viewed from an upper surface;

FIGS. 9 to 11 are diagrams illustrating a modified example of a coil component according to an embodiment of the present disclosure, illustrating various shapes of a cores and a coil;

FIG. 12 is a perspective diagram illustrating a coil component according to a second embodiment of the present disclosure; and

FIG. 13 is a perspective diagram illustrating a coil component according to a third embodiment of the present disclosure.

### DETAILED DESCRIPTION

The terms used in the example embodiments are used to simply describe an example embodiment, and are not intended to limit the present disclosure. A singular term includes a plural form unless otherwise indicated. The terms, “include,” “comprise,” “may be configured to,” and the like, of the description, are used to indicate the presence of features, numbers, steps, operations, elements, portions or combinations thereof, and do not exclude the possibility of combination or the addition of one or more features, numbers, steps, operations, elements, portions or combinations thereof. Also, the terms “disposed on,” “disposed on,” and the like, may indicate that an element is disposed on or beneath an object, and may not necessarily mean that the element is disposed on the object with reference to a gravity-direction.

Terms such as “coupled to,” “combined with,” and the like, may not only indicate that elements are directly and physically in contact with each other, but also include the configuration in which the other element is interposed between the elements such that the elements are also in contact with the other component.

The size and thickness of each component in the lead-outs may be arbitrarily indicated for ease of description, and thus, the present disclosure is not necessarily limited to the illustrated examples.

In the drawings, an X-direction is a first direction or a length direction, a Y-direction is a second direction or a width direction, a Z-direction is a third direction or a thickness direction.

Hereinafter, a coil component according to an example embodiment will be described in detail with reference to the accompanying lead-outs, and in the description with reference to the accompanying lead-outs, the same or corresponding components may be provided with the same reference numerals and overlapping descriptions thereof will not be provided.

In electronic devices, various types of electronic components may be used, and various types of coil components may be used between the electronic components to remove noise, or for other purposes.

In other words, in electronic devices, a coil component may be used as a power inductor, a high frequency inductor (HF inductor), a general bead, a high frequency bead (GHz bead), a common mode filter, and the like.

### First Embodiment

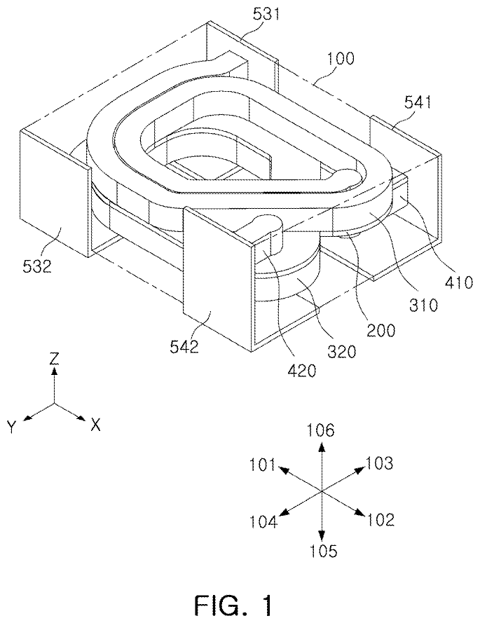

FIG. 1 is a perspective diagram illustrating a coil component according to an embodiment.

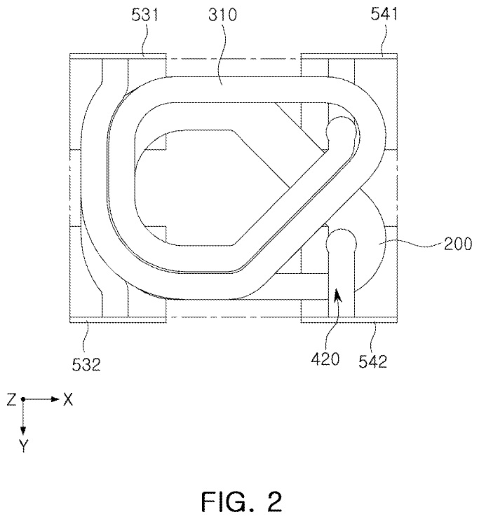

FIG. 2 is a diagram illustrating a coil component viewed from above.

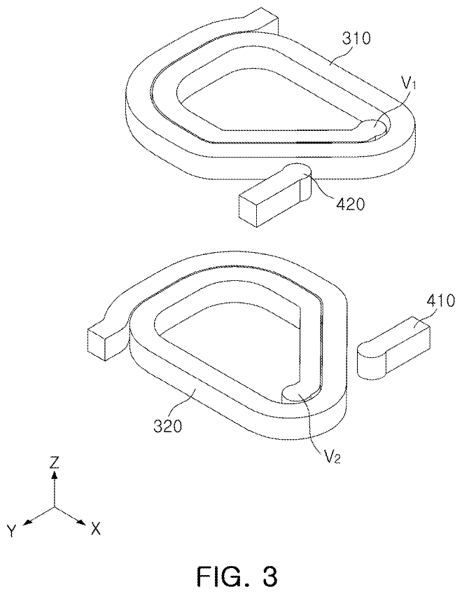

FIG. 3 is a diagram illustrating coil and a lead-out portion included in the coil component illustrated in FIG. 1.

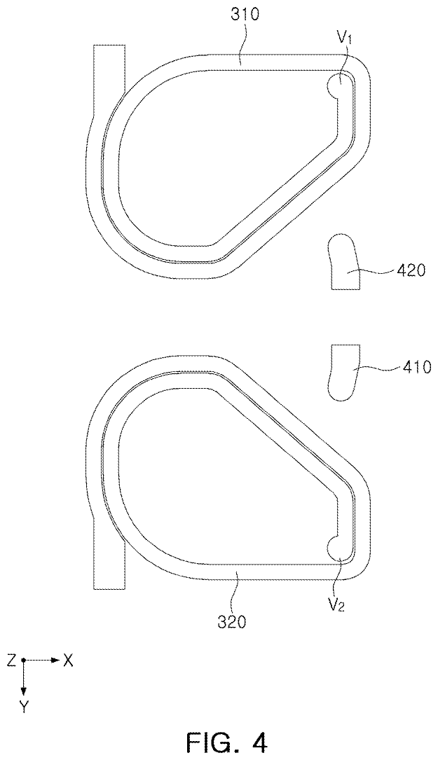

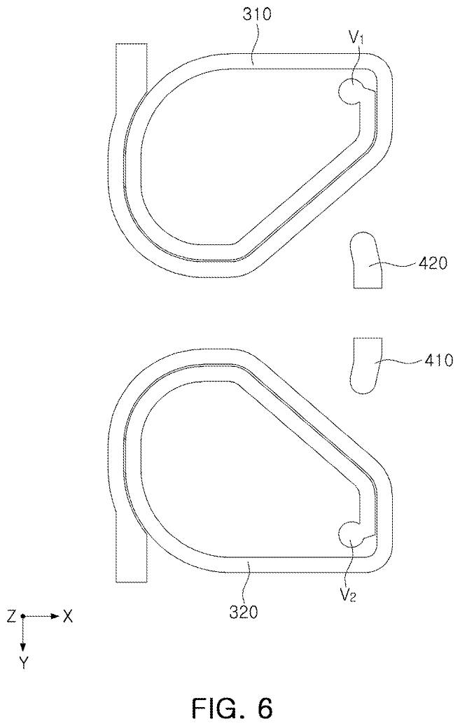

FIGS. 4 to 6 are diagrams illustrating various arrangements of vias according to an embodiment.

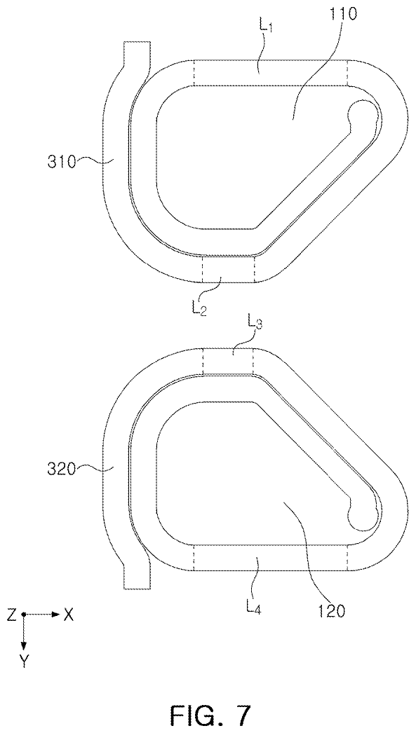

FIG. 7 is a diagram illustrating a first core of a first coil and a second core of a second coil.

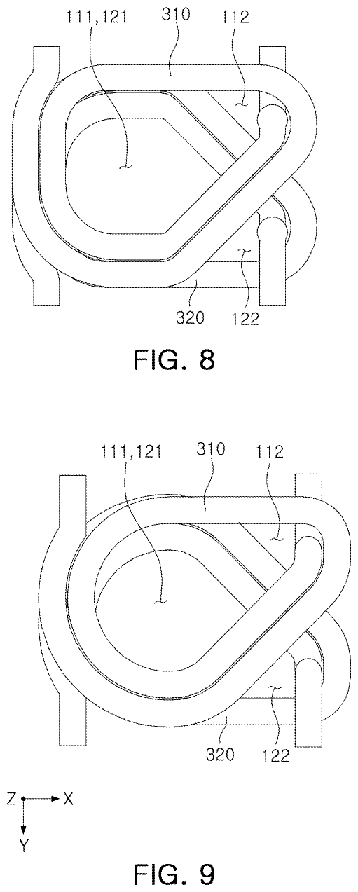

FIG. 8 is a diagram illustrating a core included in the coil component illustrated in FIG. 1, illustrating the coil component viewed from an upper surface.

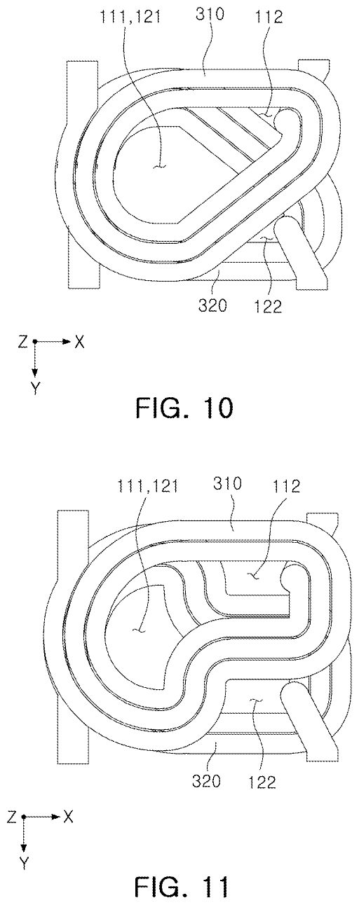

FIGS. 9 to 11 are diagrams illustrating a modified example of a coil component according to an embodiment.

Referring to FIGS. 1 to 11, a coil component 1000 according to an embodiment may include a body 100, a first coil 310, a second coil 320, a first lead-out portion 410, a second lead-out portion 420 and external electrodes 531, 541, 532, and 542.

The body 100 may form an exterior of the coil component 1000 in the example embodiment, and the support substrate 200 and the coil 300 may be disposed in the body 100.

The body 100 may have a hexahedral shape.

With reference to the directions illustrated in FIG. 1, the body 100 may include a first surface 101 and a second surface 102 opposing each other in an X-direction (a first direction), a third surface 103 and a fourth surface 104 opposing each other in a Y-direction (a second direction), and a fifth surface 105 and a sixth surface 106 opposing each other in a Z-direction (a third direction). Each of the first to fourth surfaces of the body 100 may be a surface of the body 100 connecting the fifth surface to the sixth surface of the body 100. Hereinafter, the upper and lower surfaces of the body 100 may refer to the sixth and fifth surfaces of the body 100, respectively, determined with respect to the directions in FIG. 1.

The body 100 may include an insulating resin and a magnetic material. Specifically, the body 100 may be formed by laminating one or more magnetic composite sheets in which a magnetic material is dispersed in an insulating resin. The magnetic material may be ferrite or metal magnetic powder. The ferrite may include, for example, one or more materials of a spinel ferrite such as an Mg—Zn ferrite, an Mn—Zn ferrite, an Mn—Mg ferrite, a Cu—Zn ferrite, an Mg—Mn—Sr ferrite, an Ni—Zn ferrite, and the like, a hexagonal ferrite such as a Ba—Zn ferrite, a Ba—Mg ferrite, a Ba—Ni ferrite, a Ba—Co ferrite, a Ba—Ni—Co ferrite, and the like, a garnet ferrite such as a Y ferrite, and a Li ferrite. The magnetic metal powder may include one or more selected from a group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be one or more of a pure iron powder, a Fe—Si alloy powder, a Fe—Si—Al alloy powder, a Fe—Ni alloy powder, a Fe—Ni—Mo alloy powder, Fe—Ni—Mo—Cu alloy powder, a Fe—Co alloy powder, a Fe—Ni—Co alloy powder, a Fe—Cr alloy powder, a Fe—Cr—Si alloy powder, a Fe—Si—Cu—Nb alloy powder, a Fe—Ni—Cr alloy powder, and a Fe—Cr—Al alloy powder. The magnetic metal powder may be amorphous or crystalline. For example, the magnetic metal powder may be a Fe—Si—B—Cr amorphous alloy powder, but an example embodiment of the magnetic metal powder is not limited thereto. Each particle of the ferrite and the magnetic metal powder may have an average diameter of 0.1 μm to 30 μm, but an example of the average diameter is not limited thereto. The body 100 may include two or more types of magnetic materials dispersed in resin. The notion that types of the magnetic materials are different may indicate that one of an average diameter, a composition, crystallinity, and a form of a magnetic material disposed in a resin is different from those of the other magnetic material (s). The insulating resin may include one of an epoxy, a polyimide, a liquid crystal polymer, or mixtures thereof, but the example of the resin is not limited thereto.

The support substrate 200 may be disposed in the body 100. Specifically, the support substrate 200 may be buried in the body 100. The support substrate 200 may be configured to support coils 310 and 320 described later. However, in embodiments, the support substrate 200 may not be provided, and for example, when a winding-type coil is used, the support substrate 200 may not be necessary. The coil component 1000 according to the first embodiment may relate to a thin-film coil performing electroplating on the support substrate 200.

The support substrate 200 may use a non-magnetic material or a material having different physical properties from the body 100. However, an example embodiment thereof is not limited thereto, and the support substrate 200 may be formed of the same material as that of the body 100.

The support substrate 200 is formed of an insulating material including a thermosetting insulating resin such as epoxy resin, a thermoplastic insulating resin such as polyimide, or a photosensitive insulating resin, or an insulating material impregnated with a reinforcing material such as glass fibers or inorganic fillers in the insulating resins. For example, the support substrate 200 may be formed of an insulating material such as prepreg, Ajinomoto build-up film (ABF), FR-4, bismaleimide triazine (BT) film, and photoimagable dielectric (PID) film, but an example embodiment thereof is not limited thereto.

As an inorganic filler, at least one or more selected from a group consisting of silica (SiO₂), alumina (Al₂O₃), silicon carbide (Sic), barium sulfate (BaSO₄), talc, mud, mica powder, aluminum hydroxide (Al(OH)₃), magnesium hydroxide (Mg(OH)₂), carbonic acid Calcium (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support substrate 200 is formed of an insulating material including a reinforcing material, the support substrate 200 may provide improved rigidity. When the support substrate 200 is formed of an insulating material not including glass fibers, the support substrate 200 may be advantageous in reducing the thickness of the component. When the support substrate 200 is formed of an insulating material including a photosensitive insulating resin, the number of processes for forming the coil 300 may be reduced, which may be advantageous in reducing production costs and forming fine vias.

The support substrate 200 may be formed of the same material as that of the body 100. That is, the support substrate 200 may include the same material as the material forming the body 100, and may have the same physical properties as those of the body 100. Specifically, the support substrate 200 may include an insulating resin and a magnetic material, and the magnetic material may be ferrite or a magnetic metal powder.

The first and second coils 310 and 320 may be disposed to be spaced apart from each other in the body 100, and may exhibit properties of the coil component 1000 according to the embodiment. For example, the coil component 1000 according to the embodiment may be a coupled inductor in which an absolute value of the coupling coefficient k between the first and second coils 310 and 320 is greater than 0 and less than 1, but an example embodiment thereof is not limited thereto.

The first coil 310 may have a first core 110, and the second coil 320 may have a second core 120. Since the first coil 310 forms at least one turn around the first core 110, the first core 110 may be defined as an internal region of the turn formed by the first coil 310. Similarly, since the second coil 320 forms at least one turn around the second core 120, the second core 120 may be defined as an internal region of the turn formed by the second coil 320. Since the first coil 310 and the second coil 320 are spaced apart from each other in the Z-direction (third direction), the first core 110 and the second core 120 may be spaced apart from each other in the third direction of the body 100.

The cores 110 and 120 may be formed by filling at least a portion of the magnetic composite sheet in the through-holes of the first and second coils 310 and 320 in the process of laminating and curing the magnetic composite sheet, but an example embodiment thereof is not limited thereto.

The first core 110 and the second core 120 may partially overlap each other and may have a shared core and a nonshared core. A description thereof will be described in greater detail after the description of the coil 300.

FIG. 3 is a diagram illustrating coils 310 and 320 and lead-out portions 410 and 420 of a coil component 1000 according to the embodiment. FIG. 7 is a diagram illustrating a first core of a first coil and a second core of a second coil.

Referring to FIG. 3, the first coil 310 may be disposed on one surface of the support substrate 200 and may form at least one turn around the first core 110. The other end of the first coil 310 may be connected to a first lead-out portion 410 through a first via V₁. One end of the first coil 310 may extend to the third surface 103 of the body 100.

Referring to FIG. 7, the first coil 310 may have a first linear portion L₁ adjacent to the third surface 103 of the body 100 and substantially parallel to the third surface 103 of the body 100 and a second linear portion L₂ adjacent to the fourth surface 104 of the body 100 and substantially parallel to the fourth surface 104 of the body 100. Here, the linear portion may refer to a portion of the outermost coil having substantially a zero curvature. That is, as the linear portion is substantially parallel to the third surface 103 and the fourth surface 104, the curvature may be substantially zero. As used herein, “substantially parallel” may mean that the linear portion may deviate by less than 3 degree (s) from a plane parallel to the referenced surface of the body.

Referring to FIG. 3, the second coil 320 may be disposed on the other surface of the support substrate 200 and may form at least one turn around the second core 120. The other end of the second coil 320 may be connected to a second lead-out portion 420 through a second via V₂. One end of the second coil 320 may extend to the fourth surface 104 of the body 100.

Referring to FIG. 7, the second coil 320 may have a third linear portion L₃ adjacent to the third surface 103 of the body 100 and substantially parallel to the third surface 103 of the body 100 and a fourth linear portion L₄ adjacent to the fourth surface 104 of the body 100 and substantially parallel to the fourth surface 104 of the body 100. Here, the linear portion may refer to a portion of the outermost coil having substantially a zero curvature. As the linear portion is substantially parallel to the third surface 103 and the fourth surface 104, the curvature may be substantially zero.

The length of the first linear portion L₁ may be longer than the length of the second linear portion L₂. The length of the fourth linear portion LA may be longer than that of the third linear portion L₃. The length of each linear portion may be measured by optical microscopy or electron microscopy. Other methods and/or tools appreciated by one of ordinary skill in the art, even if not described in the present disclosure, may also be used.

That is, the first and second coils 310 and 320 may have a linear region substantially parallel to the third surface 103 and the fourth surface 104 of the body 100, and since one linear portion is longer than the other linear portion, the cores 110 and 120 may have a trapezoidal shape when viewed in the third direction (Z-direction), but an example embodiment thereof is not limited thereto.

The first linear portion L₁ may be disposed closer to the second surface 102 of the body 100 than the second linear portion L₂, and the fourth linear portion L₄ may be disposed closer to the second surface 102 of the body 100 than the third linear portion L₃. Accordingly, the trapezoid may not have the shape of an isosceles trapezoid. Also, the first and second shared cores 111 and 121 may be disposed closer to the first surface 101 of the body 100 than the first and second nonshared cores 112 and 122, and the first and second nonshared cores 112 and 122 may be disposed closer to the second surface 102 of the body 100 than the first and second shared cores 111 and 121.

The first lead-out portion 410 may be disposed on the other surface of the support substrate 200 and may be connected to the first coil 310. The first lead-out portion 410 may not form a turn around the first core 110. The first lead-out portion 410 may extend to the third surface 103 of the body 100.

The second lead-out portion 420 may be disposed on one surface of the support substrate 200 and may be connected to the second coil 320. The second lead-out portion 320 may not form a turn around the second core 120. The second lead-out portion 420 may extend to the fourth surface 104 of the body 100.

In other words, the first coil 310 may be disposed on one surface of the support substrate 200 together with the second lead-out portion 420, and the second coil 320 may be disposed on the other surface of the support substrate 200 together with the first lead-out portion 410. That is, the first and second coils 310 and 320 may be disposed to be shifted from each other in the support substrate 200. In this case, the area of the shared cores 111 and 121 of the first and second cores 110 and 120 may be increased, such that magnetic flux density may be evenly distributed throughout the coil component. Also, chip space utilization may be increased as compared to a general coil component.

The first via V₁ may connect the other end of the first coil 310 to the first lead-out portion 410. Since the first and second external electrodes 531 and 541 are disposed on the third surface 103 of the body 100, the external electrodes may be connected to one end of the first coil 310 and the first lead-out portion 410. Accordingly, the first coil 310 may function as a single coil in a form extended to the first lead-out portion 410. The second via V₂ may connect the other end of the second coil 320 to the second lead-out portion 420. Since the third and fourth external electrodes 532 and 542 are disposed on the fourth surface 104 of the body 100, the external electrodes may be connected to one end of the second coil 320 and the second lead-out portion 420.

Accordingly, the second coil 320 may function as a single coil in a form extending to the second lead-out portion 420.

FIGS. 4 to 6 are diagrams illustrating various arrangements of vias according to an embodiment.

Referring to FIGS. 4 to 6, first and second vias V₁ and V₂ may be disposed in the direction of the cores 110 and 120, respectively, such that the core area may be adjusted.

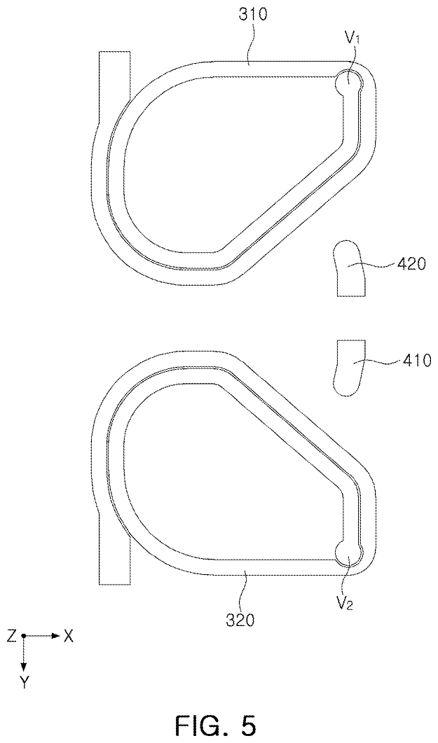

Referring to FIG. 5, an external turn adjacent to the first via in the first coil 310 may have a first groove formed on a side surface. Specifically, the first groove may be disposed between one end and the other end of the first coil 310. A portion of the first via V₁ may be accommodated in the first groove.

Referring to FIG. 5, an external turn adjacent to the second via in the second coil 320 may have a second groove formed on a side surface. Specifically, the second groove may be disposed between one end and the other end of the second coil 320. A portion of the second via V₂ may be accommodated in the second groove.

However, an example embodiment thereof is not limited thereto, and the first and second coils 310 and 320 may not have grooves.

The first and second coils 310 and 320 may satisfy a plane symmetrical relationship with respect to an arbitrary surface substantially parallel to the third surface 103 of the body 100.

The first and second coils 310 and 320 may not satisfy a plane symmetrical relationship with respect to the entirety of surfaces substantially parallel to the first surface 101 of the body 100.

Specifically, referring to FIG. 7, the first and second coils 310 and 320 may be in a plane symmetrical relationship with respect to a surface parallel to the third surface 103 of the body or with respect to a plane in the X-Z direction and passing through a central line of the third surface 103 and fourth surface 104 (not illustrated). The first and second coils 310 and 320 may not be in a plane symmetrical relationship with respect to any surface substantially parallel to the first surface 101 of the body 100. Accordingly, even when the first coil 310 is translated, the first coil 310 may not overlap the second coil 320. In this case, the first and second cores 110 and 120 may have first and second nonshared cores 112 and 122 not overlapping each other. The first and second nonshared cores 112 and 122 may be in a plane symmetrical relationship, and may be spaced apart from each other in the second direction (Y-direction) and not overlapping each other. The first and second coils 310 and 320 may be related to each other via a rotation about an axis along the third direction.

The first and second coils 310 and 320 and the first and second lead-out portions 410 and 420 may be a plating pattern formed using a generally used plating process, for example, a method such as pattern plating, anisotropic plating, and isotropic plating, and may be formed in a multilayer structure using a plurality of processes among these processes. That is, the coil component 1000 according to the first embodiment may be implemented as a thin film inductor.

Each of the coils 310 and 320 and the lead-out portions 410 and 420 may include a seed layer in contact with the support substrate 200 and a plating layer disposed on the seed layer. The seed layer may be formed by a thin film process such as sputtering or an electroless plating process. When the seed layer is formed through a thin film process such as sputtering, at least a portion of a material forming the seed layer may penetrate into the surface of the support substrate 200, which may be confirmed by a difference in concentrations of the metal material forming the seed layer in the support substrate 200 in the Z-direction of the body 100.

The thickness of the seed layer may be 1.5 μm or more and 3 μm or less. When the thickness of the seed layer is less than 1.5 μm, it may be difficult to implement the seed layer, and plating defects may occur in a subsequent process. When the thickness of the seed layer exceeds 3 μm, it may be difficult to form the plating layer to have a relatively large volume in the limited volume of the body 100, and process time may increase.

The via may include at least one or more conductive layer. For example, when the via is formed by electroplating, the via may include a seed layer formed on an internal wall of the via hole penetrating the support substrate 200 and an electroplating layer filling the via hole in which the seed layer is formed. The via seed layer may be formed together with the seed layer of the coils 310 and 320 in the same process and may be integrated with each other, or may be formed in different processes from the process of forming the seed layer of the coils 310 and 320 such that a boundary may be formed therebetween. The electrolytic plating layer of the via may be formed together with the plating layer of the coils 310 and 320 in the same process and may be integrated with each other, or may be formed in different processes from the process of forming the plating layer of the coils 310 and 320, and a boundary may be formed therebetween.

The coils 310 and 320, the lead-out portions 410 and 420, and the via V may be formed of a metal having excellent electrical conductivity, for example, silver (Ag), palladium (Pd), aluminum (Al), nickel (Ni), titanium (Ti), gold (Au), copper (Cu), platinum (Pt), or alloys thereof.

FIG. 7 is a diagram illustrating a first core of a first coil and a second core of a second coil.

FIG. 8 is a diagram illustrating a core included in the coil component illustrated in FIG. 1, illustrating the coil component viewed from an upper surface. For ease of description, the support substrates and external electrodes may not be provided.

The first core 110 may include a first shared core 111 overlapping the second core 120 and a first nonshared core 112 not overlapping the second core 120. Here, the “overlapping” may indicate that the regions forming turns may overlap when viewed in an axial direction (the Z-direction with reference to FIG. 8) of the cores 110 and 120. Accordingly, the first core 110 may include a first shared core 111 overlapping the second core 120 in the third direction and a first nonshared core 112 not overlapping the second core 120 in the third direction, and the second core 120 may include a second shared core 121 overlapping the first core 110 in the third direction and a second nonshared core 122 not overlapping the first core 110 in the third direction.

In the coil component 1000 according to an embodiment, the coils 310 and 320 may share the cores 110 and 120 and may be formed adjacent to each other, by appropriately increasing or decreasing a relative area ratio between the shared core and the nonshared core, a coupling coefficient may be adjusted. Accordingly, leakage inductance and mutual inductance may be adjusted to be desired values. When the coupling coefficient is a value close to 1, the coupling coefficient may be relatively large, and a (−) sign may refer to negative coupling.

Referring to FIGS. 7 and 8, the first and second shared cores 111 and 121 may be disposed closer to the first surface 101 of the body 100 than the first and second nonshared cores 112 and 122. The first and second nonshared cores 112 and 122 may be disposed closer to the second surface 102 of the body 100 than the first and second shared cores 111 and 121.

The first nonshared core 112 may be spaced apart from the first shared core 111 in the first direction (X-direction) of the body 100. The second nonshared core 122 may be spaced apart from the second shared core 121 in the first direction (X-direction) of the body 100, and specifically, the first nonshared core 112 may be spaced apart in a direction away from the first shared core 111. That is, the first nonshared core 112 and the second nonshared core 122 may be disposed on the same side surface in the first direction (X-direction) of the body 100 with respect to the first and second shared cores 111 and 121.

Since the first and second nonshared cores 112 and 122 in the example embodiment are disposed on the same side surface in the first direction (X-direction) of the body 100 with reference to the first and second shared cores 111 and 121, coil position distortion due to process deviation may be reduced during coil formation, and accordingly, properties deviation of the coil component may be addressed such that yield may be increased.

Referring to FIGS. 7 and 8, the first nonshared core 112 may be disposed closer to the sixth surface 106 of the body 100 than the second nonshared core 122, and the second nonshared core 122 may be disposed closer to the fifth surface 105 of the body 100 than the first nonshared core 112. That is, the first and second cores 110 and 120 may be spaced apart from each other in the third direction (Z-direction) of the body 100, which may be a result of disposing the first and second coils 310 and 320 forming the turn on the support substrate one surface and the other surface, respectively as described above.

Referring to FIGS. 7 and 8, the first nonshared core 112 may be disposed closer to the third surface 103 of the body 100 than the second nonshared core 122, and the second nonshared core 122 may be disposed closer to the fourth surface 104 of the body 100 than the first nonshared core 112.

As described above, since the first coil and the second coil 310 and 320 may satisfy a plane symmetrical relationship based on an arbitrary surface substantially parallel to the third surface 103 of the body 100, areas of the first and second cores 110 and 120 may be substantially the same. As used herein, “substantially the same” may mean that an area differs from the other area by less than ±9.5%. The area may be a cross-sectional area measured in the X-Y plane.

The first and second shared cores 111 and 121 may refer to regions in which the cores 110 and 120 overlap, and may have substantially the same area. However, the first and second shared cores 111 and 121 may be spaced apart from each other in the third direction (Z-direction).

Since the first and second nonshared cores 112 and 122 are spaced apart from each other in the second direction (Y-direction), the first and second nonshared cores 112 and 122 may not overlap each other. This is because, as described above, the first and second coils 310 and 320 may have a plane symmetrical relationship with respect to an arbitrary surface substantially parallel to the third surface 103 of the body 100. The first and second nonshared cores 112 and 122 may also be in a plane symmetrical relationship, and may have substantially the same area.

The areas of the first and second shared cores 111 and 121 may be larger than those of the first and second nonshared cores 112 and 122. However, an example embodiment thereof is not limited thereto, and the areas of the first and second shared cores 111 and 121 may be smaller than the areas of the first and second nonshared cores 112 and 122. As the area of the nonshared core increases, leakage inductance may increase, such that coupling coefficient k may decrease.

FIGS. 9 to 11 are diagrams illustrating a modified example of a coil component according to an embodiment, illustrating various shapes of a cores and a coil.

The shape of the core of the coil component according to the embodiment may vary as illustrated in FIGS. 9 to 11. The shapes of the shared cores 111 and 121 may be a fan shape or a semicircular shape, and the shapes of the nonshared cores 112 and 122 may be a triangular shape or a quadrangular shape. By adjusting the relative area ratio between the shared core and the nonshared core, the shape of the core may be varied, and accordingly, the coupling coefficient may be controlled efficiently.

Referring to FIGS. 9 to 11, the first and second shared cores 111 and 121 may be disposed closer to the first surface 101 of the body 100 than the first and second nonshared cores 112 and 122, and the first and second nonshared cores 112 and 122 may be disposed closer to the second surface 102 of the body 100 than the first and second shared cores 111 and 121.

Referring to FIGS. 9 to 11, the first nonshared core 112 may be disposed closer to the sixth surface 106 of the body 100 than the second nonshared core 122, and the second nonshared core 122 may be disposed closer to the fifth surface 105 of the body 100 than the first nonshared core 112.

Referring to FIGS. 9 to 11, the first nonshared core 112 may be disposed closer to the third surface 103 of the body 100 than the second nonshared core 122, and the second nonshared core 122 may be disposed closer to the fourth surface 104 of the body 100 than the first nonshared core 112.

Referring to FIGS. 9 to 11, the first coil 310 may have a first linear portion (L₁) adjacent to the third surface 103 of the body 100 and substantially parallel to the third surface 103 of the body 100 and a second linear portion L₂ adjacent to the fourth surface 104 of the body 100 and substantially parallel to the fourth surface 104 of the body 100. Similarly, the second coil 320 may have a third linear portion L₃ adjacent to the third surface 103 of the body 100 and substantially parallel to the third surface 103 of the body 100 and a fourth linear portion L₄ adjacent to the fourth surface 104 of the body 100 and substantially parallel to the fourth surface 104 of the body 100.

Referring to FIGS. 9 to 11, the length of the first linear portion L₁ may be longer than the length of the second linear portion L₂, and the length of the fourth linear portion L₄ may be longer than the length of the third linear portion L₃.

Referring to FIGS. 9 to 11, the first linear portion L₁ may be disposed closer to the second surface 102 of the body 100 than the second linear portion L₂, and the fourth linear portion LA may be disposed closer to the second surface 102 of the body 100 than the third linear portion L₃.

The first to fourth external electrodes 531, 541, 532, and 542 may be disposed externally of the body 100 and may be connected to the coils 310 and 320 and the lead-out portions 410 and 420. Specifically, the first and second external electrodes 531 and 541 may be disposed on the third surface 103 of the body 100, and the third and fourth external electrodes 532 and 542 may be disposed on the fourth surface 104 of the body 100.

The first and second external electrodes 531 and 541 may be disposed to be spaced apart from the third surface 103 of the body 100, and may be connected to one end of the first coil 310 and the first lead-out portion 410, respectively. The third and fourth external electrodes 532 and 542 may be disposed to be spaced apart from the fourth surface 104 of the body 100, and may be connected to one end of the second coil 320 and the second lead-out portion 420, respectively.

The first to fourth external electrodes 531, 541, 532, and 542 may be formed using a paste including a metal having excellent electrical conductivity, for example, conductive paste including nickel (Ni), copper (Cu), tin (Sn) or silver (Ag) or alloys thereof. Also, a plating layer may be provided to cover each of the first to fourth external electrodes 531, 541, 532, and 542. In this case, the plating layer may include at least one or more selected from a group consisting of nickel (Ni), copper (Cu), and tin (Sn). For example, a nickel (Ni) layer and a tin (Sn) layer may be formed in order.

### Second Embodiment

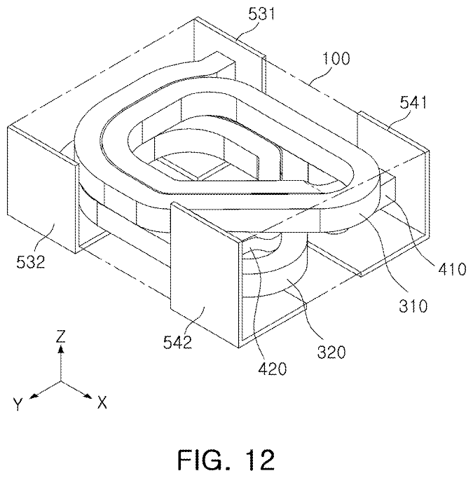

FIG. 12 is a perspective diagram illustrating a coil component according to a second embodiment.

Referring to FIG. 12, in the coil component 2000 according to the second embodiment, the presence of a wound coil may be different from the first embodiment. Accordingly, in describing the coil component 2000 according to the embodiment, only a winding type coil different from the first embodiment will be described. The descriptions in the first embodiment may be applied to the other components of the embodiment.

Referring to FIG. 12, a coil component 2000 according to the second embodiment may include a body 100, winding coils 310 and 320, and lead-out portions 410 and 420.

Referring to FIG. 12, the winding coils 310 and 320 may be buried in the body 100. The winding coils 310 and 320 may be formed by winding a metal wire such as a copper wire having a surface coated with an insulating material in a spiral shape. Also, lead-out portions 410 and 420 connected to the winding coils 310 and 320 and extending to the surface of the body 100 may be included. That is, the coil component 2000 according to the second embodiment may be implemented as a wound inductor.

Specifically, the other end of the first winding coil 310 may be formed in a spiral shape and may be connected to the first lead-out portion 410. One end of the first lead-out portion 410 and the first winding coil 310 may extend to the third surface 103 of the body 100. The other end of the second winding coil 320 may be formed in a spiral shape and may be connected to the second lead-out portion 420. One end of the second lead-out portion 420 and the second winding coil 320 may extend to the fourth surface 104 of the body 100.

The description of other components may be the same as in the first embodiment, and will thus not be provided.

### Third Embodiment

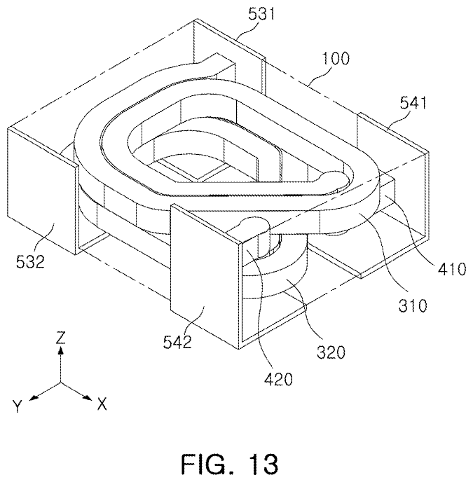

FIG. 13 is a perspective diagram illustrating a coil component according to a third embodiment.

Referring to FIG. 13, in a coil component 3000 according to the third embodiment, a shape of the coil may be different from that of the first embodiment.

Accordingly, in describing the coil component 3000 according to the embodiment, only the laminated coil component different from the first embodiment will be described. The descriptions in the first embodiment may be applied to the other components of the embodiment.

In the coil component 3000 according to the third embodiment may be implemented as a laminated coil formed by printing a coil pattern on a plurality of magnetic sheets and laminating a plurality of magnetic sheets on which the coil pattern is printed. That is, the coil component 3000 according to the third embodiment may be implemented as a multilayer inductor.

The coil component 3000 according to the third embodiment may include a ceramic body 100 in which an insulating sheet is laminated.

The ceramic body 100 may be formed by laminating a plurality of insulating sheets (not illustrated), and the plurality of insulating sheets (not illustrated) forming the ceramic body 100 may be in a sintered state, and boundaries between adjacent insulating sheets (not illustrated) may be integrated to the extent that it may be difficult to be distinct without using a scanning electron microscope (SEM). The ceramic body 100 may have a hexahedral shape, and the ceramic body 100 may include an alumina (Al₂O₃) dielectric or generally used ferrite such as Mn—Zn ferrite, Ni—Zn ferrite, Ni—Zn—Cu ferrite, Mn—Mg ferrite, and Ba ferrite, Li ferrite.

The coil 300 and the lead-out portion 400 may be formed by printing a conductive paste including a conductive metal to a predetermined thickness on a plurality of insulating sheets forming the ceramic body 100 (not illustrated). That is, the coil 300 and the lead-out portion 400 of the coil component 3000 according to the third embodiment may have a structure in which a plurality of coil patterns are laminated in the thickness direction of the body 100, and the plurality of coil patterns may be connected to each other by conductive vias and may form the coil 300 and the lead-out portion 400. In this case, a via hole for forming a conductive via may be processed in at least a portion of the magnetic sheet forming the body 100. The via hole may be formed by applying a conductive paste as in the coil.

The laminated body 100 may include a magnetic material. For example, the body 100 may include Mn—Zn ferrite, Ni—Zn ferrite, Ni—Zn—Cu ferrite, Mn—Mg ferrite, Ba ferrite, and Li ferrite, but an example embodiment thereof is not limited thereto, and the laminated body 100 may include various generally used magnetic materials.

The description of other components may be the same as in the first embodiment, and will thus not be provided.

According to aforementioned example the embodiments, in the coil component, by adjusting the area of the core portion shared by the two coil portions disposed in the body, a coupling coefficient may be finely adjusted.

While the example embodiments have been illustrated and described above, it will be configured as apparent to those skilled in the art that modifications and variations could be made without departing from the scope of the present disclosure as defined by the appended claims.

What is claimed is:

1. A coil component, comprising:
a body including a first surface and a second surface opposing each other in a first direction, a third surface and a fourth surface opposing each other in a second direction, a fifth surface and a sixth surface opposing each other in a third direction;
a support substrate disposed in the body and having one surface and the other surface;
a first coil disposed on the one surface of the support substrate and having a first core;
a second coil disposed on the other surface of the support substrate and having a second core;
a first lead-out portion disposed on the other surface of the support substrate and connected to the first coil; and
a second lead-out portion disposed on the one surface of the support substrate and connected to the second coil,
wherein the first core includes a first shared core overlapping the second core and a first nonshared core not overlapping the second core, and
wherein the second core includes a second shared core overlapping the first core and a second nonshared core not overlapping the first core.

2. The coil component of claim 1,
wherein one end of the first coil and the first lead-out portion extend to the third surface of the body, and
wherein one end of the second coil and the second lead-out portion extend to the fourth surface of the body.

3. The coil component of claim 1, further comprising:
a first via connecting the other end of the first coil to the first lead-out portion; and
a second via connecting the other end of the second coil to the second lead-out portion.

4. The coil component of claim 3,
wherein, in the first coil, an external turn adjacent to the first via has a first groove in a side surface,
wherein, in the second coil, an external turn adjacent to the second via has a second groove in a side surface,
wherein a portion of the first via is accommodated in the first groove, and
wherein a portion of the second via is accommodated in the second groove.

5. The coil component of claim 3,
wherein the first coil has a first linear portion adjacent to the third surface of the body and substantially parallel to the third surface of the body and a second linear portion adjacent to the fourth surface of the body and substantially parallel to the fourth surface of the body,
wherein the second coil has a third linear portion adjacent to the third surface of the body and substantially parallel to the third surface of the body and a fourth linear portion adjacent to the fourth surface of the body and substantially parallel to the fourth surface of the body,
wherein a length of the first linear portion is longer than a length of the second linear portion, and
wherein a length of the fourth linear portion is longer than a length of the third linear portion.

6. The coil component of claim 5,
wherein the first linear portion is disposed closer to the second surface of the body than the second linear portion, and
wherein the fourth linear portion is disposed closer to the second surface of the body than the third linear portion.

7. The coil component of claim 1,
wherein a portion of the first core overlaps the second core in the third direction, and
wherein a portion of the second core overlaps the first core in the third direction.

8. The coil component of claim 1, wherein the first and second coils satisfy a plane symmetrical relationship with respect to an arbitrary surface substantially parallel to the third surface of the body.

9. The coil component of claim 1, further comprising:
first and second external electrodes connected to one end of the first coil and the first lead-out portion, respectively;
third and fourth external electrodes connected to one end of the second coil and the second lead-out portion, respectively;
wherein the first and second external electrodes are disposed to be spaced apart from each other on the third surface of the body, and
wherein the third and fourth external electrodes are disposed to be spaced apart from each other on the fourth surface of the body.

10. The coil component of claim 1, wherein the support substrate includes a non-magnetic substance.

11. The coil component of claim 1, wherein the support substrate includes the same material as a material of the body.

12. A coil component, comprising:
a body including a first surface and a second surface opposing each other in a first direction, a third surface and a fourth surface opposing each other in a second direction, a fifth surface and a sixth surface opposing each other in a third direction;
a first coil disposed in the body and having a first core;
a second coil disposed in the body to be spaced apart from the first coil and having a second core,
wherein the first core includes a first shared core overlapping the second core in the third direction and a first nonshared core not overlapping the second core in the third direction,
wherein the second core includes a second shared core overlapping the first core in the third direction and a second nonshared core not overlapping the first core in the third direction,
wherein the first and second shared cores are disposed closer to the first surface of the body than the first and second nonshared cores, and
wherein the first and second nonshared cores are disposed closer to the second surface of the body than the first and second shared cores.

13. The coil component of claim 12,
wherein the first nonshared core is disposed closer to the sixth surface of the body than the second nonshared core, and
wherein the second nonshared core is disposed closer to the fifth surface of the body than the first nonshared core.

14. The coil component of claim 12,
wherein the first nonshared core is disposed closer to the third surface of the body than the second nonshared core, and
wherein the second nonshared core is disposed closer to the fourth surface of the body than the first nonshared core.

15. The coil component of claim 12, wherein areas of the first and second cores are substantially the same.

16. The coil component of claim 15, wherein areas of the first and second nonshared cores are substantially the same.

17. A coil component, comprising:
a body;
a support substrate disposed in the body and having one surface and the other surface;
a first coil disposed on the one surface of the support substrate and having a first core;
a second coil disposed on the other surface of the support substrate and having a second core;
a first lead-out portion disposed on the other surface of the support substrate and connected to the first coil; and
a second lead-out portion disposed on the one surface of the support substrate and connected to the second coil,
wherein the first core includes a first shared core overlapping the second core and a first nonshared core not overlapping the second core,
wherein the second core includes a second shared core overlapping the first core and a second nonshared core not overlapping the first core, and
wherein, in a plan view of the coil component, the first and second nonshared cores are disposed on a same side of the first and second shared cores.

18. The coil component of claim 17,
wherein the body includes a first surface and a second surface opposing each other in a first direction, a third surface and a fourth surface opposing each other in a second direction, a fifth surface and a sixth surface opposing each other in a third direction,
wherein one end of the first coil and the first lead-out portion extend to the third surface of the body, and
wherein one end of the second coil and the second lead-out portion extend to the fourth surface of the body.

19. The coil component of claim 18, further comprising:
a first via connecting the other end of the first coil to the first lead-out portion; and
a second via connecting the other end of the second coil to the second lead-out portion.

20. The coil component of claim 19,
wherein, in the first coil, an external turn adjacent to the first via has a first groove in a side surface,
wherein, in the second coil, an external turn adjacent to the second via has a second groove in a side surface,
wherein a portion of the first via is accommodated in the first groove, and
wherein a portion of the second via is accommodated in the second groove.
